(19) United States
(12) Patent Application Publication
(10) Pub. No.: US 2026/0170267 A1
(43) Pub. Date: Jun. 18, 2026

(54) SYSTEMS AND METHODS FOR EVALUATING THE ACCURACY OF A RESPONSE TO QUALITATIVE CONTROLS

(71) Applicant: THE BANK OF NEW YORK MELLON, New York, NY (US)

(72) Inventors: Uddipt MITTER, New York, NY (US); Peter VIGLUCCI, New York, NY (US)

(21) Appl. No.: 19/042,121

(22) Filed: Jan. 31, 2025

(30) Foreign Application Priority Data
Dec. 12, 2024 (IN) 202411098447

(51) Int. Cl. G06F 40/40; G06N 3/042

(52) U.S. Cl. CPC G06F 40/40; G06N 3/042

(57) ABSTRACT

Systems and methods for evaluating the accuracy of a response to qualitative controls receive a first dataset; select a first set of prompts in a prompt carousel based on the first dataset; determine based on the first dataset, whether or not additional context is required to generate a prompt; based on the determining, generate a prompt responsive to the first dataset; evaluate the generated prompt in a large language model (LLM); and output the evaluation.

### CROSS-REFERENCE TO RELATED APPLICATIONS

This Application claims priority to India Patent Application No. 202411098447, filed Dec. 12, 2024, which is incorporated herein by reference in its entirety.

### BACKGROUND

In any business, operational risks are inherent to running day-to-day activities. To mitigate these risks such that they remain within acceptable boundaries, controls are put in place. These controls act as safeguards, reducing exposure to financial, operational, regulatory, and security threats. However, as the business environment evolves and becomes increasingly complex, the challenge of maintaining effective control over risks intensifies. Specifically, the explosion in the volume, velocity, and variety of data has made it incredibly difficult to enable these controls to continue to function effectively.

Asserting completeness, accuracy and validity of text entered in response to qualitative control assessments has traditionally involved manually reviewing the data by a qualified reviewer. However, challenges in ensuring the completeness, accuracy, and validity of text entered during qualitative control assessments stem from the growing complexity of modern operational environments, which span thousands of processes and technology stacks. Traditionally, this task has been handled manually by qualified reviewers who carefully examine data inputs, but as the volume of assessments increases, manual review becomes impractical, slow, and prone to human error. This method struggles to scale, often resulting in missed errors and incomplete assessments due to fatigue, oversight, or inconsistency among different reviewers.

Even semi-automated approaches, which combine manual oversight with automation tools, face similar challenges, as they still rely heavily on human intervention, are limited in their ability to adapt to diverse scenarios, and often cannot account for context-specific nuances in data entry. Fully automated systems, while faster, introduce their own set of limitations. They frequently depend on pre-set rules (e.g., using a configured blacklist of words to identify whether certain text is valid or not) or machine learning models that may not fully capture the complexity or variability of the processes they are assessing. These systems can generate false positives or negatives, failing to account for subtleties that a human reviewer might catch. Moreover, both manual and automated approaches tend to rely on sample-based testing, which reviews only a portion of the data, leaving gaps in coverage and increasing the likelihood that critical errors go unnoticed. This leaves organizations vulnerable to undetected risks, making it clear that current systems—whether manual, semi-automated, or automated—are insufficient for managing the complexities and scale of today's operational environments.

### SUMMARY

Aspects of the disclosure relate to methods, systems, and/or apparatuses for asserting the completeness, validity and accuracy of data made available in response to a qualitative control assessment using AI/ML models.

In some aspects, the techniques described herein relate to a method for evaluating the accuracy of a response to qualitative controls, including: receiving, by a processor, a first dataset; selecting, by the processor, a first set of prompts in a prompt carousel based on the first dataset; determining, by the processor, based on the first dataset, whether or not additional context is required to generate a prompt; based on the determining, generating, by the processor, a prompt responsive to the first dataset; evaluating, by the processor, the generated prompt in a large language model (LLM); and outputting, by the processor, the evaluation.

In some aspects, the techniques described herein relate to a method, wherein the first dataset includes at least a question, an answer, and an instruction for evaluating the answer with respect to the question.

In some aspects, the techniques described herein relate to a method, wherein the first dataset is received from a continuous control monitoring (CCM) feed.

In some aspects, the techniques described herein relate to a method, wherein the first set of prompts is a few-shot example set in the prompt carousel.

In some aspects, the techniques described herein relate to a method, wherein, when additional context is required to generate a given prompt, the processor is configured to query a vector database based on the first dataset.

In some aspects, the techniques described herein relate to a method, wherein the vector database is populated based on information in a knowledge base.

In some aspects, the techniques described herein relate to a method, wherein the assessment is of at least one of the completeness, accuracy, or validity of the first dataset.

In some aspects, the techniques described herein relate to a system for evaluating the accuracy of a response to qualitative controls, including: a computer system including one or more processors programmed with computer program instructions which, when executed, cause the computer system to: receive a first dataset; select a first set of prompts in a prompt carousel based on the first dataset; determine based on the first dataset, whether or not additional context is required to generate a prompt; based on the determining, generate a prompt responsive to the first dataset; evaluate the generated prompt in a large language model (LLM); and output the evaluation.

In some aspects, the techniques described herein relate to a system, wherein the first dataset includes at least a question, an answer, and an instruction for evaluating the answer with respect to the question.

In some aspects, the techniques described herein relate to a system, wherein the first dataset is received from a continuous control monitoring (CCM) feed.

In some aspects, the techniques described herein relate to a system, wherein the first set of prompts is a few-shot example set in the prompt carousel.

In some aspects, the techniques described herein relate to a system, wherein, when additional context is required to generate a given prompt, the processor is configured to query a vector database based on the first dataset.

In some aspects, the techniques described herein relate to a system, wherein the vector database is populated based on information in a knowledge base.

In some aspects, the techniques described herein relate to a system, wherein the assessment is of at least one of the completeness, accuracy, or validity of the first dataset.

In some aspects, the techniques described herein relate to a non-transitory computer-readable media including instructions that, when executed by one or more processors, cause operations including: receiving a first dataset; selecting a first set of prompts in a prompt carousel based on the first dataset; determining based on the first dataset, whether or not additional context is required to generate a prompt; based on the determining, generating a prompt responsive to the first dataset; evaluating the generated prompt in a large language model (LLM); and outputting the evaluation.

In some aspects, the techniques described herein relate to a non-transitory computer-readable media, wherein the first dataset includes at least a question, an answer, and an instruction for evaluating the answer with respect to the question.

In some aspects, the techniques described herein relate to a non-transitory computer-readable media, wherein the first dataset is received from a continuous control monitoring (CCM) feed.

In some aspects, the techniques described herein relate to a non-transitory computer-readable media, wherein the first set of prompts is a few-shot example set in the prompt carousel.

In some aspects, the techniques described herein relate to a non-transitory computer-readable media, wherein, when additional context is required to generate a given prompt, the processor is configured to query a vector database based on the first dataset.

In some aspects, the techniques described herein relate to a non-transitory computer-readable media, wherein the vector database is populated based on information in a knowledge base; and wherein the assessment is of at least one of the completeness, accuracy, or validity of the first dataset.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for evaluating the accuracy of a response to qualitative controls, in accordance with at least one embodiment

FIG. 2 depicts an example method for evaluating the accuracy of a response to qualitative controls, in accordance with at least one embodiment;

FIG. 3 depicts an example set of prompts from a prompt carousel are shown according to at least one embodiment;

FIG. 4 depicts an example output, shown according to at least one embodiment; and

FIG. 5 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

The reliance on manual intervention in control monitoring, as outlined above, leads to significant scalability issues. In environments with complex and growing processes, control monitoring activities often rely on sample-based methods, where only a subset of the data is reviewed manually. This approach is limited in scope and fails to provide comprehensive oversight, especially when critical processes are involved. For instance, in the context of change management, a control might be responsible for ensuring that all Technology Request-for-Changes (RFCs) are raised appropriately. However, without proper oversight, the underlying systems and processes may be exposed to the risk of unauthorized changes being deployed in production IT systems. Conventional control techniques typically only verify whether mandatory fields are filled, but this does not guarantee that the information is complete, valid, or accurate. As the number of processes grows and regulatory pressures demand stricter governance, these shortcomings become even more pronounced.

In contrast to traditional approaches such as a sample-based approach, the methods and systems described herein offer more robust solutions for evaluating the accuracy of a response to qualitative controls. By providing reasonable assurance that the content entered in response to control checks is complete, valid, and accurate, embodiments of these systems and methods may reduce or eliminate the need for manual qualitative assessments. For example, these systems and methods may automatically determine whether qualitative content is fit-for-purpose as a control parameter, ensuring more effective oversight. As part of an automated Continuous Controls Monitoring (CCM) system, the systems and methods described herein may not only identify issues but also alert relevant users about potential deficiencies in the controls applied to a given process.

Current automated systems offer advantages over manual measures, but they also face challenges. For example, LLMs may struggle to fully understand or gauge what constitutes a complete, valid, or accurate response due to several intrinsic limitations in their design and function. These models are primarily pattern recognition systems, trained on vast amounts of text data to predict the next word or phrase in a sequence. While this enables them to generate coherent and contextually relevant text, they do not possess true comprehension of the underlying meaning or context in the way humans do. Their understanding of “completeness” is derived from statistical correlations in the data, not from an awareness of the requirements of a specific task or domain.

When it comes to evaluating completeness, LLMs rely on patterns of language they have encountered during training. If the model's training data does not include examples of thorough and detailed responses specific to the task at hand, it may fail to recognize missing information or necessary details. LLMs do not have the ability to engage in critical thinking or to ask follow-up questions for clarification, which are often crucial when determining whether a response is fully addressing all relevant aspects of a qualitative control.

In terms of validity, LLMs are not equipped with the inherent ability to verify facts or cross-check information against external sources. They operate based on patterns in the data, meaning that if their training set contains inaccurate, outdated, or biased information, the model may generate responses that seem plausible but are ultimately invalid. Additionally, LLMs lack the capability to assess the logical coherence of complex arguments or to apply domain-specific rules that are often essential for determining the validity of a response in areas like legal, financial, or scientific controls.

Accuracy is similarly affected by the lack of true understanding and real-time knowledge. LLMs cannot assess whether a piece of information is accurate in a dynamic or evolving context because they do not have access to up-to-date facts or databases. Even when they do generate factually correct information, they often lack the ability to recognize when accuracy is paramount in nuanced situations. Moreover, their output is influenced by the biases present in the training data, meaning that the model can sometimes generate responses that, while linguistically correct, reflect inaccuracies or skewed interpretations of certain topics.

LLMs'limitations in evaluating completeness, validity, and accuracy stem from their reliance on statistical associations rather than true understanding, their inability to verify real-world facts, and their lack of critical thinking and domain-specific judgment. Without these faculties, LLMs may struggle to properly evaluate responses to queries provided in a controls environment.

Accordingly, embodiments of the systems and methods for evaluating the accuracy of a response to qualitative controls described herein provide an improved AI approach to qualitative assessment of a given dataset with the intent of opining on its completeness, accuracy, and validity to support a CCM regime. This approach introduces systems and methods that generate or otherwise provide a set of example prompts from a prompt carousel, based on data received from the CCM. The data may include the control question and the corresponding answer provided by a user. In some embodiments, the example prompts may feature sets of sample responses that are ranked, for example, from 1 to 5, where 1 reflects the least adequate response and 5 reflects the most complete, accurate, and/or valid response to a particular question. These rankings may be used to provide a comparative framework, illustrating what constitutes an incomplete or insufficient answer versus progressively better responses in terms of completeness, accuracy, and validity.

In some embodiments, the system may further include the ability to detect when additional context is necessary for a more accurate assessment. In such instances, the system may retrieve supplementary data from a vector database, which is populated with information from a knowledge base. This retrieval allows the system to go beyond the initial question-and-answer pair, enriching the evaluation process with relevant, additional information.

The example prompts from the prompt carousel, as well as the additional context, may then be incorporated into a prompt for a large language model (LLM), alongside the original CCM data, including the control question and the user's response. This process may enable the LLM to assess the response with a more complete understanding, drawing on both the original data and supplementary information. By doing so, the system supports a more accurate, thorough, and valid qualitative assessment, enhancing the overall effectiveness of the CCM platform's monitoring capabilities.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions. These and other features are described in detail herein with reference to the foregoing figures.

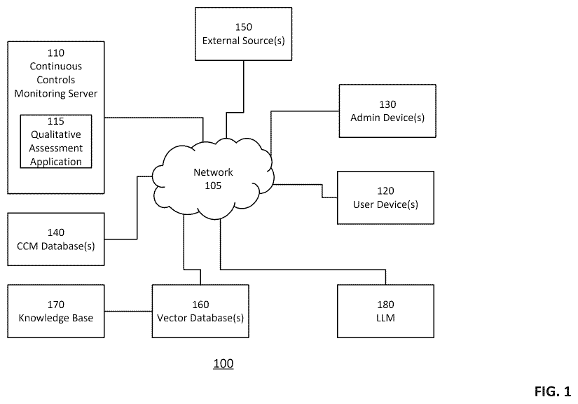

FIG. 1 depicts an illustrative system 100 for evaluating the accuracy of a response to qualitative controls, in accordance with at least one embodiment. FIG. 1 illustrates a functional block diagram of an embodiment of a controls management system 100 within which at least some of the disclosed techniques may be implemented. The controls management system 100 may be established to permit the automated or semi-automated evaluation of responses provided to qualitative controls, e.g., in a CCM platform, as described herein.

In some embodiments, various devices and applications described herein may be configured to communicate via network 105. In some embodiments, computing devices and servers described herein may communicate over network 105, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 may be any combination of the above, which may be a combination of private and public networks.

In some embodiments, each of the elements of controls management system 100 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically).

For example, in some embodiments, an entity may execute, on a server or other computing system, e.g., CCM server 110, a qualitative assessment application, e.g., qualitative assessment application 115. Moreover, in some examples, the entity may also provide users access to a qualitative assessment application on various user devices (e.g., devices 120 and/or 130, described herein), which may be a web-based application hosted by a computing system managed by or provisioned by the entity, or which communicates with such a computing system via an application programming interface (API). Accordingly, one or more of the devices/systems/elements depicted herein may communicate with one another via messages transmitted over network 105, such as the Internet and/or various other local area networks. For example, one or more applications may communicate via messages transmitted over network 105.

In some example embodiments, CCM server 110 may include, host, or otherwise execute qualitative assessment application 115. In some embodiments, qualitative assessment application 115 may be a user facing application with which a user interfaces to access various aspects of the systems and methods described herein. For example, one or more users may use one or more user devices 120, e.g., to input data (e.g., text or other inputs), e.g., responsive to requests for such data. For example, in the context of a CCM system, users may have various interactions with CCM server 110. As understood herein, CCM is an automated tool typically used by organizations to continuously track, assess, and report on the effectiveness of their internal controls, particularly those related to financial reporting, compliance, and operational efficiency, among others. In some embodiments, CCM server 110 may integrate with various enterprise systems, such as ERP platforms, and monitoring key controls in real-time to detect anomalies, risks, or deviations from established policies. It may reduce the reliance on periodic manual audits by providing ongoing visibility into control performance, which may help the organization respond more quickly to emerging issues.

Accordingly, in various embodiments, users may access user devices 120 to input or otherwise provide data and other information into CCM server 110. In some embodiments, users may input data through periodic updates, such as manually adding exceptions, explanations, or confirmations when the system flags potential issues. In some embodiments, end users may be staff members or other users within an organization who interact with the CCM system regularly, e.g., on a daily basis. For example, they may be responsible for reviewing and responding to alerts and notifications generated by the system when it detects a potential issue, risk, or policy deviation. These users may provide feedback by investigating flagged transactions or control breaches, offering explanations, and resolving discrepancies. For example, if the system flags an unauthorized access attempt a financial transaction exceeding a predefined threshold, or processing/execution errors, these end users may review the incident, determine whether it represents a legitimate concern or a false positive, and provide input regarding appropriate action.

Similarly, in some embodiments, administrators and/or other managers within an entity or organization may use admin devices 130 to input data and other information, e.g., with respect to the CCM system, its various users and settings, etc. For example, admin users, e.g., from internal audit, compliance, or IT departments, may be responsible for managing and/or configuring the CCM system. One or more of these users may be more focused on the quality of data entered into the system, and the overall efficiency of the system. For example, such users may set up the system's monitoring parameters and control rules, defining what types of risks or anomalies the system should focus on, what kinds of inputs are sufficiently responsive to issues or errors, etc. In some embodiments, admin users may establish thresholds (e.g., quality control standards, unusual data entries, etc.) and determine how the system flags certain data, activities, etc., ensuring that it aligns with organizational policies and compliance frameworks. In some embodiments, admin users may maintain and adjust the system as the organization evolves. They may respond to feedback from end users by fine-tuning the parameters to refine qualitative responses, reduce false positives or other errors. Admins may also integrate new data sources, adjust control rules as regulations change, or introduce new controls as needed.

In some embodiments, administrators or other users may be provided with the ability to input example questions and/or answers into a database such as a prompt carousel (described in detail herein), enhancing the system's adaptability and ensuring that the generated prompts align with the specific needs of the organization. This functionality may allow admins to curate and customize the set of example responses that the system uses to guide evaluations. Administrators may input control questions commonly used within their continuous controls monitoring (CCM) platform, along with corresponding example answers that vary in quality, ranging from incomplete or inaccurate responses to fully comprehensive and valid ones.

The input process may allow admins to associate each example response with a ranking, such as a scale from 1 to 5, where 1 represents a poor-quality response and 5 represents an ideal or fully adequate response. By doing so, admins may tailor the prompt carousel to reflect the specific standards and criteria relevant to their domain, ensuring that the qualitative assessment process is aligned with the organization's unique controls and compliance requirements. This customization capability provides greater control over the guidance provided to users, as it allows the system to reflect industry-or organization-specific nuances that generic examples may not capture.

In some embodiments, the system may also allow admins to update or modify the prompt carousel over time, ensuring that it remains responsive to evolving control frameworks, new regulations, or changing organizational priorities. By empowering admins with the ability to input and manage example questions and answers, the system may enhance its flexibility and relevance, leading to more accurate assessments and continuous improvement of the CCM platform's monitoring capabilities.

In some embodiments, qualitative assessment application 115 may include a user interface through which a user may interact with controls management system 100 via various user devices, e.g., devices 120 and/or 130, and vice versa. For example, to assess a completeness of Change Description field in a Request for Change to systems in Production, an administrator may desire to configure or otherwise interact with qualitative assessment application 115. According to embodiments, the administrator, using admin device 130, may interact with a user interface of qualitative assessment application 115, and may adjust thresholds and/ratings for responses to qualitative assessments, input process options, data elements, prompt examples, etc., as described herein. Similarly, in some embodiments, qualitative assessment application 115 may be configured to monitor usage and/or inputs made by users via user devices 120 (e.g., the entering of a response in the Change Description field in the aforementioned Request for Change to systems in Production), and evaluate the accuracy of the response to qualitative controls, as described in detail herein.

In some example embodiments, qualitative assessment application 115 may be configured to coordinate with CCM database(s) 140 and external source(s) 150. CCM database 140 may be one or a collection of databases, configured to collect data relating to CCM server 110 and controls management system 100. For example, a data-pipeline may be set up as a part of an automated Continuous Controls Monitoring framework. This data may then be organized or standardized, e.g., into specific data-structures, as described herein, which may then be used to train a Machine Learning model, as described herein.

In some embodiments, external sources 150 may be any external source with which qualitative assessment application 115 may be configured to interact, e.g., external LLMs, Generative AI models, APIs, other organizations or databases, or even other separate systems within an organization, etc.

In some example embodiments, qualitative assessment application 115 may be configured to coordinate with vector database(s) 160 and/or knowledge base 170. As explained herein, in some embodiments, vector database 160 may be used in conjunction with knowledge base 170 (which may be any appropriate form of database or repository) to support the evaluation of qualitative responses in a continuous controls monitoring (CCM) platform. In some embodiments, vector database 160 may be designed to store and retrieve data in the form of vectors, which are mathematical representations of information. These vectors may encode semantic relationships between pieces of data, allowing for efficient similarity searches and context retrieval. In the context of this system, vector database 160 may be populated with information that has been transformed into vectors, enabling the system to retrieve relevant information based on the content of a given query.

In some embodiments, knowledge base 170, in turn, may serve as a structured repository of domain-specific information against which a large language model (LLM) 180 may evaluate the given text in a generated prompt. In some embodiments, knowledge base 170 may be populated with representative constructs, which may include a corpus of documents such as policies, procedures, regulations, and internal guidelines relevant to the controls being monitored. Additionally, knowledge base 170 may include knowledge graphs, which represent relationships between concepts and entities within the domain, further enriching the system's ability to understand and apply context during evaluations. In some embodiments, other data relevant to evaluation of prompts may be store or otherwise included in knowledge base 170. In some embodiments, knowledge base 170 may be further configured to access, or otherwise be provided with information from, external sources 150, e.g., such as information from other platforms or knowledge sources, etc.

To populate vector database 160, in some embodiments, the information in knowledge base 170—whether it may consist of documents, knowledge graphs, or other structured or unstructured data—may be processed and transformed into vector embeddings. These embeddings may be mathematical representations that capture the semantic meaning of the content, allowing vector database 160 to store these vectors for later retrieval. When a prompt is being prepared for LLM 180 to evaluate a qualitative response (as described in more detail herein), qualitative assessment application 115 may detect the need for additional context and query the vector database, which may perform similarity searches to find vectors that closely match the content or meaning of the response or question being evaluated. This process may allow qualitative assessment application 115 to access and incorporate relevant information from the knowledge base, enriching the evaluation process by ensuring that it considers a broader and more informed context.

By populating the vector database with embeddings derived from the knowledge base, the system may be enabled to efficiently retrieve contextually relevant information, providing a more complete prompt and enabling more accurate and meaningful assessments of the text being evaluated. This structure may allow the LLM to draw on a rich repository of domain knowledge, improving the quality of its evaluations by grounding them in the organization's specific constructs and frameworks.

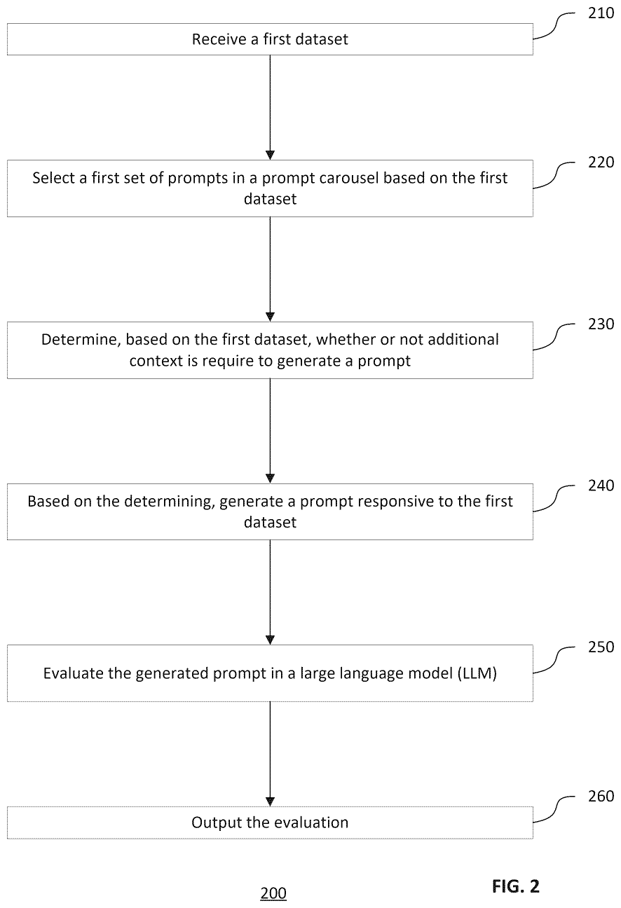

These and other features of controls management system 100 will be further understood with reference to the controls management method 200 of FIG. 2, herein.

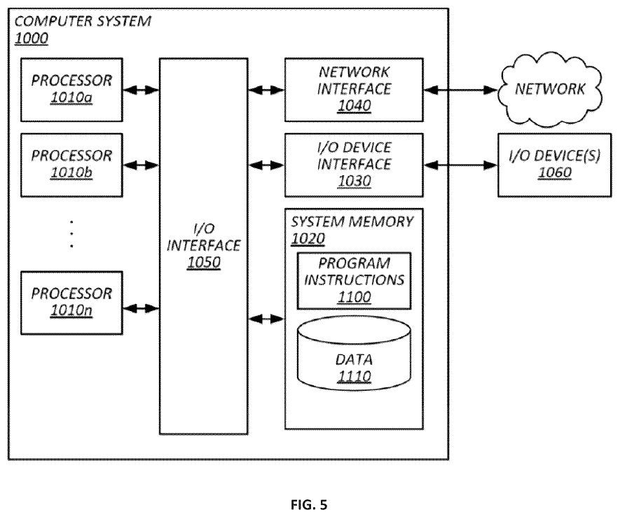

FIG. 2 depicts an example method evaluating the accuracy of a response to qualitative controls, in accordance with at least one embodiment. In various embodiments, method 200 may be implemented by qualitative assessment system 100, executing code in one or more processors therein. For example, in some embodiments, method 200 may be performed on a computer (e.g., computer system 1000 of FIG. 5) having one or more processors (e.g., processor(s) 1010 of FIG. 5) and memory (e.g., system memory 1020 of FIG. 5), and one or more code sets, applications, programs, modules, and/or other software stored in the memory and executing in or executed by one or more of the processor(s).

Method 200 begins at step 210 when a processor (e.g., of CCM server 110) is configured to receive a first dataset. The first dataset may include at least a question, an answer, and an instruction for evaluating the answer with respect to the question. This dataset may be received from a continuous controls monitoring (CCM) feed, which continuously streams control-related data such as user responses to specific compliance or control-related questions. The dataset may arrive in real-time or as part of a scheduled evaluation cycle, depending on the architecture of the CCM platform. The question in the dataset may correspond to a control question intended to verify compliance with a specific regulatory or internal policy requirement. The accompanying answer may be a response provided by a user or system, and the instruction may dictate how the response should be evaluated, focusing on factors such as completeness, accuracy, or validity. In this stage, in some embodiments, the processor may parse and preprocess the dataset, ensuring it is formatted appropriately for subsequent analysis.

At step 220, in some embodiments, the processor may be configured to select a first set of prompts from a prompt carousel based on the first dataset. In some embodiments, a prompt carousel may serve as a structured set of example prompts designed to guide the evaluation of qualitative data, such as responses to control questions in a continuous controls monitoring (CCM) platform. In some embodiments, the prompt carousel may operate by providing a range of examples that vary in quality, with each example ranked on a predefined scale according to specific evaluation criteria such as, e.g., completeness, accuracy, and/or validity. The purpose of the carousel is to present the LLM with concrete examples that illustrate what constitutes an inadequate, average, or ideal response in relation to the control question being assessed. By offering these examples, the carousel may help provide a more consistent and informed evaluation process, as explained herein.

In some embodiments, each prompt in the carousel may be associated with a corresponding score and/or reason, making it clear why a particular response is ranked at a given level. In some embodiments, the score may be a numerical representation of the quality of the response, while the reason may provide a detailed explanation of the rationale behind the scoring. This combination of a scored example and a reason may enable the LLM to compare user-submitted responses against these example prompts, offering a more objective basis for judging the quality of responses.

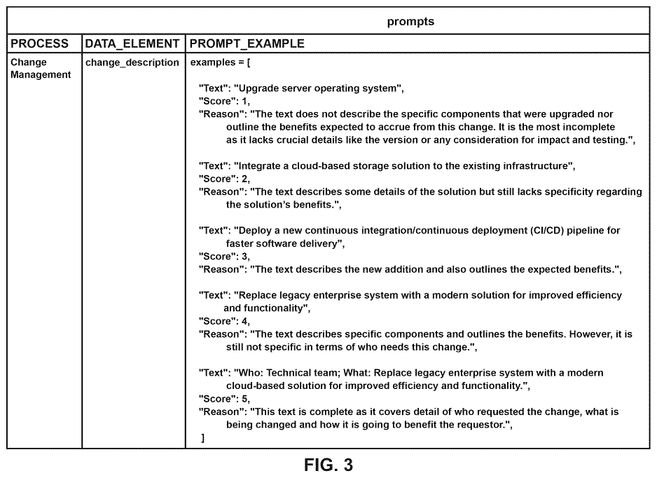

Turning, briefly to FIG. 3, an example set of prompts from a prompt carousel are shown according to at least one embodiment. As shown, example set of prompts 300 provides for assessing the completeness of a “Change Description” field in a “Request for Change” to systems in production. The prompt carousel presents multiple examples of change descriptions, each with a score from 1 to 5, with 1 being the least complete and 5 being the most complete. The first example, with a score of 1, reads “Upgrade server operating system” and is deemed incomplete because it lacks crucial details such as which specific components were upgraded, the version involved, and consideration of the expected benefits and impact of the change. The corresponding reason further explains why this response is insufficient, citing the absence of essential information like testing procedures or impacts on production.

Another example, with a score of 2, “Integrate a cloud-based storage solution to the existing infrastructure,” provides more detail but still falls short of a higher score because it lacks specific information about the solution's benefits. As the scores increase, the example responses become more complete, with the final example, scored 5, reading: “Who: AST Technical team; What: Replace legacy ERP system with a modern, Azure cloud-based solution for improved efficiency and functionality.” This highest-rated example is considered complete because it identifies the key parties involved, specifies the change, and explains the benefits, covering all necessary components of a well-rounded response.

Returning to FIG. 2, in some embodiments, the prompt carousel may dynamically select and present these example prompts based on the specific dataset being evaluated. For instance, if the system is assessing a response related to a “Change Description” field, the carousel may generate and display example prompts that are directly relevant to that context. The selection process may rely on predefined categories or training data to enable the prompt carousel to be tailored to the specific type of control or question being evaluated. Additionally, the carousel may be updated over time, allowing administrators to input new examples or refine existing ones based on evolving evaluation standards or new control requirements.

In some embodiments, the prompt carousel may serve as both a guidance tool and an evaluation aid. For example, in some embodiments, one or more example prompts may be shown or otherwise provided to users, e.g., on a display screen, to help users understand what constitutes a better response by comparing their own submissions to the example prompts. In some embodiments, with respect to the LLM, the carousel can provide training data and/or be directly incorporated into the prompt for the LLM to improve the accuracy of the model's evaluation. The structured, ranked nature of the prompt carousel thus enables more precise, consistent, and context-aware assessments of qualitative data within a CCM framework.

In some embodiments, the first set of prompts may be structured as a few-shot example set, providing comparative examples that help guide the evaluation of the response in the dataset. The selection process may involve comparing the question and answer from the first dataset to similar queries and responses stored in a repository of few-shot examples, which are designed to help the system understand and assess varying levels of response quality. These few-shot examples may be ranked, illustrating different levels of completeness, accuracy, or validity, and they may be specifically tailored to match the control topic or context reflected in the dataset. By leveraging the few-shot example set, the system may enable the processor to evaluate the user's response in relation to model answers that range from poor to exemplary, providing a scalable and adaptive means of assessing qualitative inputs.

In some embodiments, at step 230, the processor may be configured to determine, based on the first dataset, whether or not additional context is required to generate a prompt. This determination may depend on several factors, such as whether the information in the answer is sufficient to meet the evaluation criteria specified by the instruction. If the processor detects gaps in the user's response, such as missing details that may impact the assessment of completeness, accuracy, or validity, it may trigger a need for further context. In such cases, the processor may analyze the dataset for ambiguities or insufficient clarity that could hinder proper evaluation. This analysis may involve a preliminary comparison of the user's response against the few-shot examples and predefined benchmarks for high-quality answers. If the dataset is found to lack key contextual information, such as references to specific regulations, policies, or detailed explanations, the processor may conclude that additional context is necessary for the evaluation to proceed accurately.

In some embodiments, the prompt carousel may include a configuration setup where a pre-defined and deterministic configuration determines whether additional context is required for evaluating a user-submitted response. This configuration may be based on preset rules or criteria, enabling the system to make a consistent decision on whether to proceed with additional context retrieval. In such embodiments, the system may automatically apply these predefined rules to the dataset received, ensuring that context is only retrieved when necessary, thus optimizing processing efficiency and response accuracy.

In some embodiments, the payload (the first dataset) received from the Continuous Controls Monitoring (CCM) feed may already carry sufficient information for the prompt carousel to assess whether additional context is needed. The payload may include a control question, user response, and instructions for evaluating the response. In cases where the provided dataset includes all necessary details—such as relevant contextual information, historical data, or references to applicable policies—the prompt carousel may be configured to determine that no further context is required. This allows the system to proceed with generating and presenting prompts without the need to query external sources, streamlining the evaluation process. The system's ability to determine the need for context dynamically based on the content of the CCM payload provides a more efficient and targeted evaluation, minimizing unnecessary queries and improving the performance of the large language model (LLM).

At step 240, in some embodiments, based on the determination made in the previous step, the processor may be configured to generate a prompt responsive to the first dataset. If it has been determined that additional context is required, the processor may query a vector database to retrieve relevant information that enhances the understanding of the user's response. The vector database may be populated with vectors derived from a knowledge base and/or external sources. The knowledge base may include documents such as policies, regulations, procedures, and knowledge graphs that map out relationships between key concepts in the domain of controls management. By querying the vector database, the processor may retrieve contextually relevant vectors that are semantically similar to the dataset's content. This additional information may be used to enrich the prompt, ensuring that the large language model (LLM) has all necessary context to accurately evaluate the dataset. If no additional context is required, the processor may proceed to generate a prompt directly from the first dataset, utilizing the question, answer, and instructions provided.

At step 250, in some embodiments, the processor may be configured to evaluate the generated prompt using a LLM. The LLM, leveraging its capacity for natural language processing and understanding, may evaluate the prompt to assess the quality of the user's response to the control question. The evaluation may focus on one or more aspects of the response, such as its completeness, accuracy, or validity, as defined by the original instructions in the dataset. The few-shot example set from the prompt carousel, along with any additional context retrieved from the vector database, may be provided to the LLM as part of the prompt to guide its assessment. The LLM may then analyze the structure, content, and relevance of the user's response, comparing it to the expected standards indicated by the examples. The evaluation may include determining whether the response sufficiently answers the control question, whether it is factually correct and aligned with the relevant policies or regulations, and whether it meets the depth of detail required by the instruction.

At step 260, in some embodiments, the processor may be configured to output the evaluation. The evaluation may be presented as a score or qualitative feedback on the user's response, detailing whether the response meets the criteria for completeness, accuracy, and validity. The output may be delivered through a user interface within the CCM platform, providing users or auditors with actionable insights into the quality of the control response. The output may include detailed feedback generated by the LLM, such as suggestions for improving the response, highlighting areas where it falls short, or confirming its adequacy. In some embodiments, the output may also include references to the few-shot examples or additional context used in the evaluation, offering transparency into the rationale behind the assessment. In some embodiments, this final step completes the evaluation cycle, enabling continuous improvement in the monitoring and control processes within the CCM framework. In other embodiments, the CCM framework may be executed against the dataset. For example, if a response is deemed to fall below a defined threshold score, then the answer may be flagged or marked as a deviation. In some embodiments, a user may be prompted to revise their response (e.g., in real-time).

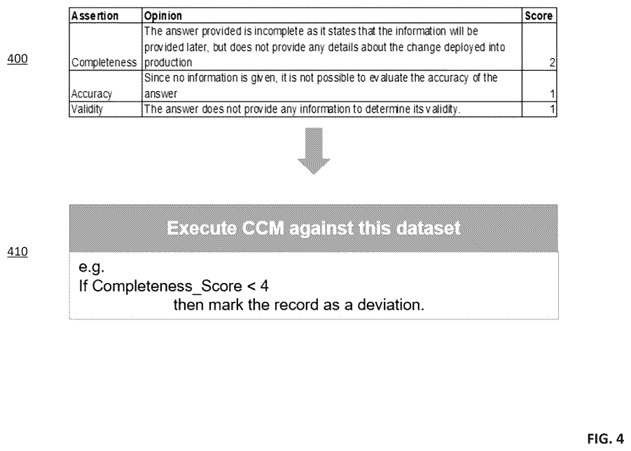

Turning briefly to FIG. 4, an example output is shown according to at least one embodiment. FIG. 4 include an example output 400, as well as an example CCM-based evaluation 410 of the response, based on the evaluation.

In some embodiments, this improved AI approach to qualitative assessment addresses and improves upon previous systems from a technical perspective by introducing advanced mechanisms for context-aware evaluation and dynamic feedback generation, which were often absent or limited in earlier systems. Traditional methods of assessing the completeness, accuracy, and validity of control responses in continuous controls monitoring (CCM) platforms have relied heavily on rule-based systems or manual review processes. These earlier systems often lacked the adaptability and contextual understanding required to accurately gauge the quality of responses, especially when responses were incomplete or missing crucial context.

From a technical standpoint, the introduction of a prompt carousel with ranked example responses significantly enhances the system's ability to guide users in crafting higher-quality answers. By comparing user-submitted answers to a set of ranked examples, the system provides a clear framework for evaluating qualitative controls, offering insight into what constitutes an insufficient response versus an ideal one. This reduces the reliance on static rules and allows for a more dynamic and nuanced evaluation, which can be particularly important in complex control environments where rigid criteria are insufficient for capturing the full spectrum of acceptable responses.

Moreover, this approach improves on previous systems by incorporating the ability to retrieve and integrate additional contextual information from a vector database. In previous systems, the evaluation of responses was often limited to the immediate question and answer pair, which could result in inadequate assessments if crucial contextual information was missing. The ability to recognize when additional context is needed and to retrieve relevant data from a knowledge base enables the system to make more informed evaluations, reducing the likelihood of false negatives or positives in the assessment process.

Finally, the integration of these elements into a large language model (LLM) workflow further enhances the technical capabilities of the system. Unlike earlier systems that may have relied on keyword matching or predefined patterns, the LLM's ability to process natural language, combined with the prompt carousel and contextual retrieval, allows for a more sophisticated, semantic understanding of user responses. This enables the system to evaluate not just the presence of information, but also its relevance and coherence in relation to the control question, leading to more accurate and valid assessments. Thus, this approach improves upon previous systems by providing a more flexible, context-aware, and accurate method for assessing qualitative controls within CCM platforms.

Some embodiments may execute the above operations on a computer system, such as the computer system of FIG. 5, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for evaluating the accuracy of a response to qualitative controls, comprising:
receiving, by a processor, a first dataset;
selecting, by the processor, a first set of prompts in a prompt carousel based on the first dataset;
determining, by the processor, based on the first dataset, whether or not additional context is required to generate a prompt;
based on the determining, generating, by the processor, a prompt responsive to the first dataset;
evaluating, by the processor, the generated prompt in a large language model (LLM); and
outputting, by the processor, the evaluation.

2. The method as in claim 1, wherein the first dataset comprises at least a question, an answer, and an instruction for evaluating the answer with respect to the question.

3. The method as in claim 1, wherein the first dataset is received from a continuous control monitoring (CCM) feed.

4. The method as in claim 1, wherein the first set of prompts is a few-shot example set in the prompt carousel.

5. The method as in claim 1, wherein, when additional context is required to generate a given prompt, the processor is configured to query a vector database based on the first dataset.

6. The method as in claim 5, wherein the vector database is populated based on information in a knowledge base.

7. The method as in claim 1, wherein the assessment is of at least one of the completeness, accuracy, or validity of the first dataset.

8. A system for evaluating the accuracy of a response to qualitative controls, comprising:
a computer system comprising one or more processors programmed with computer program instructions which, when executed, cause the computer system to:
receive a first dataset;
select a first set of prompts in a prompt carousel based on the first dataset;
determine based on the first dataset, whether or not additional context is required to generate a prompt;
based on the determining, generate a prompt responsive to the first dataset;
evaluate the generated prompt in a large language model (LLM); and
output the evaluation.

9. The system as in claim 8, wherein the first dataset comprises at least a question, an answer, and an instruction for evaluating the answer with respect to the question.

10. The system as in claim 8, wherein the first dataset is received from a continuous control monitoring (CCM) feed.

11. The system as in claim 8, wherein the first set of prompts is a few-shot example set in the prompt carousel.

12. The system as in claim 8, wherein, when additional context is required to generate a given prompt, the processor is configured to query a vector database based on the first dataset.

13. The system as in claim 12, wherein the vector database is populated based on information in a knowledge base.

14. The system as in claim 8, wherein the assessment is of at least one of the completeness, accuracy, or validity of the first dataset.

15. A non-transitory computer-readable media comprising instructions that, when executed by one or more processors, cause operations comprising:
receiving a first dataset;
selecting a first set of prompts in a prompt carousel based on the first dataset;
determining based on the first dataset, whether or not additional context is required to generate a prompt;
based on the determining, generating a prompt responsive to the first dataset;
evaluating the generated prompt in a large language model (LLM); and
outputting the evaluation.

16. The non-transitory computer-readable media as in claim 15, wherein the first dataset comprises at least a question, an answer, and an instruction for evaluating the answer with respect to the question.

17. The non-transitory computer-readable media as in claim 15, wherein the first dataset is received from a continuous control monitoring (CCM) feed.

18. The non-transitory computer-readable media as in claim 15, wherein the first set of prompts is a few-shot example set in the prompt carousel.

19. The non-transitory computer-readable media as in claim 15, wherein, when additional context is required to generate a given prompt, the processor is configured to query a vector database based on the first dataset.

20. The non-transitory computer-readable media as in claim 19, wherein the vector database is populated based on information in a knowledge base; and wherein the assessment is of at least one of the completeness, accuracy, or validity of the first dataset.
